(19) United States
(12) Patent Application Publication
(10) Pub. No.: US 2022/0343914 A1
(43) Pub. Date: Oct. 27, 2022

(54) METHOD AND SYSTEM OF GENERATING AND TRANSMITTING A TRANSCRIPT OF VERBAL COMMUNICATION

(71) Applicant: KWB Global Limited, Wanchai (HK)

(72) Inventors: Imran Bonser, Nollamara (AU); Lara Rehani, Wanchai (HK)

(21) Appl. No.: 17/634,872

(22) PCT Filed: Aug. 14, 2020
(86) PCT No.: PCT/AU2020/050854

§ 371 Date: Feb. 11, 2022

(30) Foreign Application Priority Data
Aug. 15, 2019 (AU) 2019902964

(51) Int. Cl. G10L 15/26; G10L 15/02; H04L 67/306; H04L 12/18

(52) U.S. Cl. CPC G10L 15/26; G10L 15/02; H04L 67/306; H04L 12/1831

(57) ABSTRACT

The present invention relates to a method of generating and transmitting a transcript of a verbal communication. The method comprises creating a recording of at least one speaker participating in the verbal communication; processing the recording through a parsing process in which an audio stream is analysed to produce a speaker record automatically identifying one or more portions of the audio stream that correspond to at least one known speaker profile; processing the recording through a transcription process in which the recording is transcribed into one or more text segments to create a communications transcript representative of the verbal communication; assigning one or more segments of the communications transcript to the at least one speaker based on the speaker record; generating a final communications transcript by inserting into the communications transcript; and presenting to a user a copy of the final communications transcript.

### TECHNICAL FIELD

The disclosure relates, generally, to a computer-implemented method and system of generating and transmitting a transcript of a verbal communication and, more particularly, to a computer-implemented method and system for automatically generating and transmitting a transcript of a single party or multi-party communication in substantially real-time. The disclosure has particular, but not necessarily exclusive, application to transcription and transmittal of multi-party communications that occur in the same location and/or across a communications network.

### BACKGROUND

As a common aspect of everyday communications and conversations, people typically communicate with each other either verbally (such as, for example, in face-to-face conversations or via teleconferencing/videoconferencing across a communications network), or, in written messages. Traditionally, and before the introduction of certain technological advancements, written communications between people took the form of handwritten or typed notes and letters. More recently, the Internet has made communication by chat and email messages a preferred form of communication.

Communication devices (such as, for example, telephones and mobile devices) are used in many different environments, and it is sometimes difficult for listeners to understand the words of the speaker. For example, in the case of poor wireless communication channel conditions, congested networking, high interference, etc., voice packets (e.g. in a Voice-Over-IP (VoIP) call) are often lost and it becomes difficult for listeners to understand what the speaker is saying. This may also be the case, for example, in the case of mismatching environments such as where the speaker is in a silent environment but listeners are in a noisy environment. In such a case, listeners may not be able to perceive or understand the conversation correctly. By way of further example, listeners may experience difficulties in understanding the speaker because of the speaker's accent or intonation (which may, or course, also occur in face-to-face communications).

For many users, it would be convenient to receive a transcription of all verbal communications in text format rather than having to repeatedly access audio recordings of those conversations (to the extent that they are available). Accordingly, it would be desirable to provide an efficient and at least semi-automated mechanism for transcribing verbal communications (or at least audio recordings of those verbal communications) to text, so that the text can be provided to an intended recipient (or to a program or application programming interface (API) that utilises the text). This procedure and system could be applied for transcribing almost any form of verbal communication to a corresponding text.

One approach that has been directed to addressing the above problems is the use of fully automated speech recognition (ASR) systems to process verbal communications (or audio recordings of those communications) to produce a corresponding text transcription. While the accuracy of ASR software has improved (particularly in the case of users that undertake training to enable the software to recognize the characteristics of a specific speaker's speech patterns), such programs still have a relatively high error rate when attempting to recognize speech produced by a person for which the system has not been trained.

As is often the case in multiple party verbal conversations, there is a substantial amount of disorganized and unstructured conversation and interplay, and overlap, between the speaking parties. For example, speakers change relatively frequently (depending on the forum), sometimes with participants speaking simultaneously or over one another, and with varying quality of input and audio resulting therefrom. In many instances, it is virtually impossible for the person or software providing a transcription of the conversation to accurately and predictably identify the person speaking in the instance of each position in the audio. Furthermore, relying upon the transcriptionist's hearing and ability to identify and designate the identity of the speaker is unreliable and subject to error. Many of the presently available dictation and transcription systems lack the ability to distinguish between speakers in multi-party communications and to provide a complete and reliable transcription of the conversation.

In view of the above-mentioned problems of the prior art, there is a need for an improved method and system of generating a transcript of a multi-party communication, or at least a working alternative. There is also a need for an improved method and system for securely transmitting (and, as required, storing) a transcript of the multi-party communication in order to enable users access (for the purposes, for example, of review and/or correction of the transcript) at a later stage.

In this specification where a document, act or item of knowledge is referred to or discussed, this reference or discussion is not an admission that the document, act or item of knowledge or any combination thereof was at the priority date, publicly available, known to the public, part of the common general knowledge; or known to be relevant to an attempt to solve any problem with which this specification is concerned.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

The present disclosure relates to a computer-implemented method of generating and transmitting a transcript of a verbal communication, the method comprising:

creating a recording of at least one speaker participating in the verbal communication;

processing the recording through a parsing process in which an audio stream is analysed to produce a speaker record automatically identifying one or more portions of the audio stream that correspond to at least one known speaker profile;

processing the recording through a transcription process in which the recording is transcribed into one or more text segments to create a communications transcript representative of the verbal communication;

assigning one or more segments of the communications transcript to the at least one speaker based on the speaker record;

generating a final communications transcript by inserting into the communications transcript, based on the at least one known speaker profile, information identifying the at least one speaker; and

presenting to a user a copy of the final communications transcript.

In an embodiment, the verbal communication is a multi-party communication and the one or more segments of the communications transcript are assigned to an individual speaker based on the speaker record. However, a person skilled in the art will appreciate that the verbal communication may alternatively be a single-party communication, for example, in the form of a lecture, a presentation, taking verbal notes or the like.

Thus, a speaker of the verbal communication is automatically recognised based on the known speaker profile of the speaker. As will be described below, the speaker profile may be generated based on a voice sample of the speaker and information identifying the speaker such as first and last name, profession of the speaker and the like.

Embodiments of the present invention have significant advantages. In particular, a written communications transcript representative of the verbal communication may be provided automatically and in substantially real-time in which one or more of the speakers that participate in the verbal communication are identified, for example, labelled by first name and last name together with a date and time stamp. In this way, the written communications transcript will clearly identify who speaks at what time. Further advantages and features of embodiments of the invention will be described below.

In the step of creating a recording, the method may further comprise creating a continuous audio recording of the verbal communication, such as the multi-party communication. The continuous audio recording may be stored for one or more of an analysis or processing step, and transmission to a user and/or a party to the verbal communication. As part of the transcription process, and possibly for review and quality assurance (QA) purposes, it may be desirable to a user (or interested party) to receive and/or have access to the continuous audio recording of the verbal communication in addition to the final communications transcript.

The method may further comprise a step of creating one or more copies of the recording. For example, the steps of processing the recording through a parsing process and/or a transcription process may be conducted on the one or more copies of the recording. Specifically, a first copy of the recording may be processed through a parsing process and a second copy of the recording may be processed through a transcription process.

In an embodiment, the parsing process may further include the steps of segmenting the audio stream into one or more individualised speaker segments, and grouping the one or more individualised speaker segments based on common speaker elements. This may be particularly applicable if the verbal communication relates to a multi-party communication in which multiple parties communicate with each other.

The step of segmenting the audio stream may further include the step of identifying speaker change points in the audio stream. For example, the step of identifying speaker change points may include one or more of identifying gaps and/or changes, in the audio stream, between speakers involved in the multi-party communication, and referencing the at least one known speaker profile to identify the one or more portions of the audio stream that correspond to a speaker matching the at least one known speaker profile. Thus, the method may recognise and differentiate multiple speakers/voices in one audio stream. This feature may also be referred to as speaker/voice diarisation. In this way, the identity of individual speakers of a multi-party communication can be correctly labelled, for example, together with a date and time stamp.

In this regard, the step of identifying gaps may comprise detecting a period of silence in the audio stream. The method may then process one or more portions of the audio stream prior to the detected period of silence such that the final communications transcript may be provided substantially in real-time. Thus, the audio stream may be transcribed segment by segment.

In an embodiment, the transcription process may include the further step of generating the text segments via automated speech recognition (ASR). Examples of such an ASR software may include an in-house developed software, the Cloud Speech-to-Text application programming interface (API) available from Google™, or the Watson™ Speech-to-Text application available from IBM™.

The step of assigning one or more segments of the communications transcript may include the steps of aligning the speaker record with the communications transcript based on audio and/or textual cues, and allocating the information identifying individual speakers to each of the one or more text segments based on the at least one known speaker profile. The step of aligning the speaker record with the communications transcript may be achieved using timestamped records of the one or more portions of the audio stream that correspond to at least one known speaker profile (as well as possibly corresponding timestamped records of the one or more text segments used to create the communications transcript).

The step of generating a final communications transcript may include one or more of

inserting into the communications transcript, based on the at least one known speaker profile, the information identifying the individual speakers. The information may, for example, include a first name of the speaker, a last name of the speaker, a position of the speaker or any other suitable information identifying the speaker. The information may further include a date and time stamp and location of the speaker. For an unknown speaker, the information may include an unknown speaker marker identifying a speaker where additional identity information, such as a name, of the individual speaker is unknown from the at least one known speaker profile. For example, an unknown speaker marker may identify a speaker by a non-specific designation (such as, for example, ‘Speaker 1’ or ‘Speaker A’) in the event that an identified speaker is not matched to the at least one known speaker profile. In this way, each individual speaker of the verbal communication can be directly identified and clearly labelled thereby improving the readability and accuracy of the final communications transcript.

The step of processing the recording through a parsing process and the step of processing the recording through a transcription process may preferably occur substantially simultaneously. In this regard, it may be necessary to create a first and second copies of the recording as described above. Even more so, the method may be conducted to provide the final communications transcript in substantially real-time.

Prior to the step of presenting to a user a copy of the final communications transcript, the method may include a step of encrypting the final communications transcript and/or the continuous audio recording, and transmit the encrypted final communications transcript and/or the encrypted continuous audio recording to a user and/or a party to the verbal communication. A person skilled in the art will appreciate that any suitable encryption methods are envisaged. Even more so, a person skilled in the art will appreciate that any suitable information presented to a user may be encrypted, including but not limited the final communications transcript, the audio recording, uploaded or shared document files such as non-disclosure agreements or agendas, and speaker profiles such as voice samples and identification information.

In a specific embodiment, the method may be conducted substantially in real-time. In this way, a substantially live transcript may be provided to a user or a party of the verbal communication. This feature has significant advantages as will be described with reference to the specific examples below.

In an embodiment, the method may comprise a step of generating the at least one speaker profile of an individual speaker. The at least one speaker profile may be stored on the computer for future access. A person skilled in the art will appreciated that the at least one speaker profile may be encrypted as briefly outlined above. In a specific embodiment, the method may comprise a step of generating speaker profiles of any unknown speakers. The step of generating the at least one speaker profile of an individual speaker may comprise creating a voice recording of an audio sample of the individual speaker. The method may comprise a step of analysing the voice recording for tonal and pitch measurements. In addition, the step of generating the at least one speaker profile of an individual speaker may comprise obtaining the information identifying the speaker, such as name of the speaker, location, position, company and any other suitable information. For example, together with the audio sample, the speaker may state his/her name and any other information required for the enrolment process.

In a specific embodiment, the method may comprise a step of translating the text of all or part of the final communications transcript into a language different to the language of the verbal communication, such as the language spoken by parties during the multi-party communication. The step of translating the text may be performed in substantially real-time.

Embodiments of the present disclosure further relate to software that when installed on a mobile communication device may cause the mobile communication device to perform the above method. Further embodiments of the present disclosure relate to an Application Programming Interface that when installed on a mobile communication device as part of a user application may cause the mobile communication device to perform the above method.

The present disclosure also relates to a computer-implemented system of generating and transmitting a transcript of a verbal communication, the system comprising:

a recording device for recording at least one speaker; and

a processing system configured to perform the above described method, wherein the processing system is a server processing system.

The present disclosure also relates to a computer-implemented system of generating and transmitting a transcript of a verbal communication, the system comprising:

a computer server accessible through a communications network, the computer server arranged to receive information about the verbal communication through the communications network;

a processor, communicatively coupled to the computer server, to one or more graphical displays for displaying information, and to one or more input devices, the processor being configured to:

create, via a recording device, a recording of at least one speaker of the verbal communication;

process, via the processor, the recording through a parsing process in which an audio stream is analysed to produce a speaker record identifying one or more portions of the audio stream that correspond to at least one known speaker profile;

process, via the processor, the recording through a transcription process in which the recording is transcribed into one or more text segments to create a communications transcript representative of the verbal communication;

assign, via the processor, one or more segments of the communications transcript to the at least one speaker based on the speaker record;

generate, via the processor, a final communications transcript by inserting into the communications transcript, based on the at least one known speaker profile, information identifying the at least one speaker; and

present to a user, via the communications network, a copy of the final communications transcript.

In the step of creating a recording of at least one speaker, the processor may be further configured to create a continuous audio recording of the verbal communication, such as a single party or multi-party communication. The continuous audio recording may be stored for one or more of an analysis or processing step by the processor; and transmission, via the communications network, to a user and/or a party to the communication. As part of the transcription process, and possibly for review and quality assurance (QA) purposes, it may be desirable to a user (or interested party) to receive and have access to the continuous audio recording of the verbal communication in addition to the final communications transcript.

The processor may be configured to create one or more copies of the recording such that the parsing process and/or transcription process may be applied to the one or more copies. Specifically, the processor may be configured to process a first copy of the recording through a parsing process, and to process a second copy of the recording through a transcription process.

In the step of processing the recording through a parsing process, the processor may be further configured to segment the audio stream into one or more individualised speaker segments, and group the one or more individualised speaker segments based on common speaker elements.

The processor may be further configured to identify speaker change points in the audio stream. For example, the step of identifying speaker change points may include one or more of identifying gaps and/or changes, in the audio stream, between speakers involved in the multi-party communication, and referencing the at least one known speaker profile to identify the one or more portions of the audio stream that correspond to a speaker matching the at least one known speaker profile.

In the step of processing the recording through a transcription process, the processor may be further configured to generate the text segments via automated speech recognition (ASR). Examples of such an ASR software may include the Cloud Speech-to-Text application programming interface (API) available from Google™, or the Watson™ Speech-to-Text application available from IBM™.

The step of assigning one or more segments of the communications transcript may include the steps of aligning the speaker record with the communications transcript based on audio and/or textual cues, and allocating the identity of individual speakers to each of the one or more text segments based on the at least one known speaker profile. The step of aligning the speaker record with the communications transcript may preferably be achieved using timestamped records of the one or more portions of the audio stream that correspond to at least one known speaker profile (as well as possibly corresponding timestamped records of the one or more text segments used to create the communications transcript).

The step of generating a final communications transcript may include one or more of inserting into the communications transcript, based on the at least one known speaker profile, the information identifying the individual speakers. The information may, for example, include a first name, a last name, a position of the individual speaker, company information, location information, timestamp or any other suitable information identifying the speaker. If a speaker is unknown to the system, the information may include an unknown speaker marker for the speaker where the identity of the individual speaker is unknown from the at least one known speaker profile. For example, an unknown speaker marker may identify a speaker by a non-specific designation (such as, for example, ‘Speaker 1’ or ‘Speaker A’) in the event that an identified speaker is not matched to the at least one known speaker profile.

Prior to the step of presenting to a user a copy of the final communications transcript, the processor may be further configured to encrypt the final communications transcript and/or the continuous audio recording, and transmit, via the communications network, the encrypted final communications transcript and/or the encrypted continuous audio recording to a user and/or an interested party, such as a party to the multi-party communication.

The present disclosure also relates to a computer-implemented method as performed by a mobile application installed on a mobile communication device to facilitate generating and transmitting a transcript of a verbal communication, the method comprising:

creating, via a recording device, a recording of at least one speaker participating in the verbal communication;

processing the recording through a parsing process in which an audio stream is analysed to produce a speaker record identifying one or more portions of the audio stream that correspond to at least one known speaker profile;

processing the recording through a transcription process in which the recording is transcribed into one or more text segments to create a communications transcript representative of the verbal communication;

assigning one or more segments of the communications transcript to the at least one speaker based on the speaker record;

generating a final communications transcript by inserting into the communications transcript, based on the at least one known speaker profile, information identifying the at least one speaker; and

presenting to a user, via the communications network, a copy of the final communications transcript.

The communication device may comprise a display device to facilitate presentation of the copy of the final communications transcript via the mobile application.

Software that when installed on a computer, such as a mobile communication device, may cause the computer to perform the above method. An Application Programming Interface that when installed on a computer, such as a mobile communication device, as part of a user application may cause the computer to perform the above method.

The present disclosure also relates to a mobile communication device comprising:

a recording device, preferably located within the mobile communications device operated by a user;

a program memory to store a user application installed on the mobile communication device;

a data port to facilitate communication with an application server via a communications network; and

a processor to
create, via the recording device, a recording of at least one speaker participating in the verbal communication;
process the recording through a parsing process in which an audio stream is analysed to produce a speaker record identifying one or more portions of the audio stream that correspond to at least one known speaker profile;
process the recording through a transcription process in which the recording is transcribed into one or more text segments to create a communications transcript representative of the verbal communication;
assign one or more segments of the communications transcript to the at least one speaker based on the speaker record;
generate a final communications transcript by inserting into the communications transcript, based on the at least one known speaker profile, information identifying the at least one speaker; and
present to a user, via the communications network, a copy of the final communications transcript.

The mobile communication device may further comprise a display device and an input device to facilitate interaction by the user with the user application.

### BRIEF DESCRIPTION OF DRAWINGS

Embodiments of the present invention will now be described with reference to the accompanying drawings. These embodiments are given by way of illustration only and other embodiments of the invention are also possible. Consequently, the particularity of the accompanying drawings is not to be understood as superseding the generality of the preceding description. In the drawings:

FIG. 1 is a schematic block diagram illustrating a system of generating and transmitting a transcript of a multi-party communication in accordance with a representative embodiment of the present disclosure;

FIG. 2 is a schematic block diagram illustrating a web-based system of a system of generating and transmitting a transcript of a multi-party communication in accordance with an alternative embodiment of the present disclosure;

FIG. 3 is a schematic block diagram illustrating a method of generating and transmitting a transcript of a multi-party communication in accordance with an embodiment of the present disclosure; and

FIG. 4A-4F are schematic overviews of exemplary applications and features of a method of generating and transmitting a transcript of a multi-party communication in accordance with embodiments of the present disclosure.

### DESCRIPTION OF EMBODIMENTS

Representative embodiments of the present disclosure relate, generally, to a computer-implemented method and system of generating and transmitting a transcript of a verbal communication and, more particularly, to a computer-implemented method and system for automatically generating and transmitting a transcript of a multi-party communication. The transcript of the multi-party communication may be generated and transmitted to a user and/or a party of the multi-party communication in substantially real-time. In this way, a substantially live communications transcript may be provided.

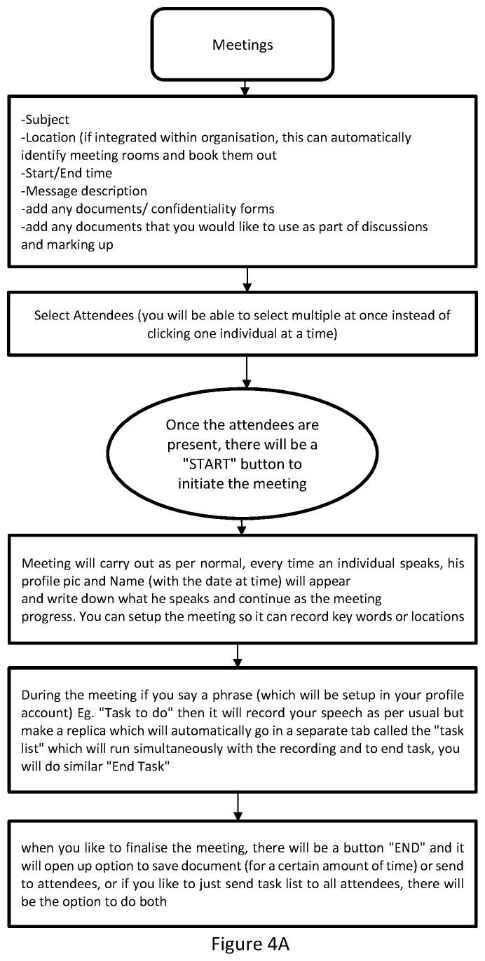

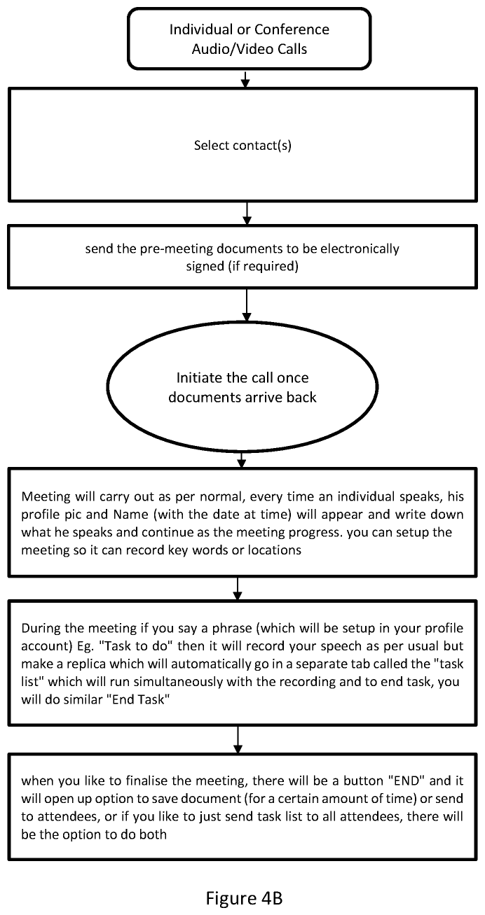

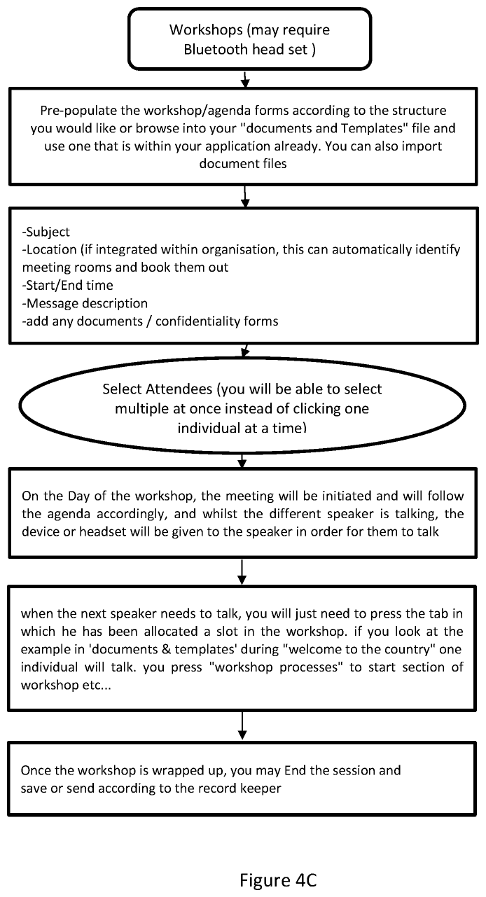

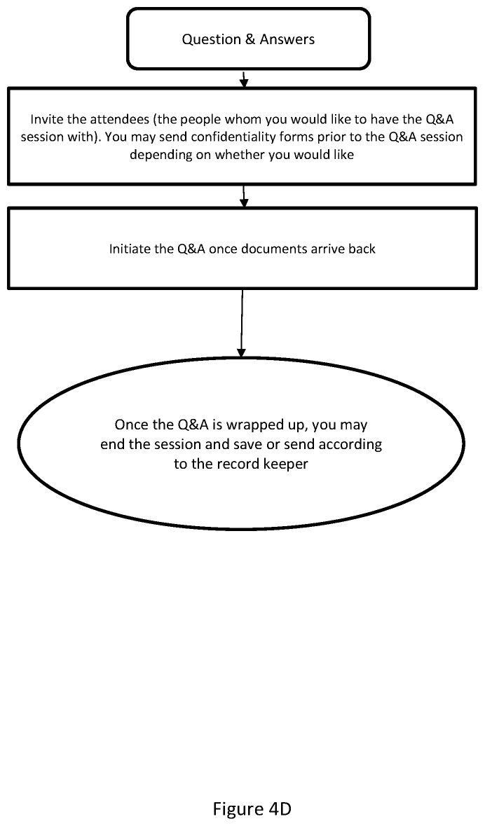

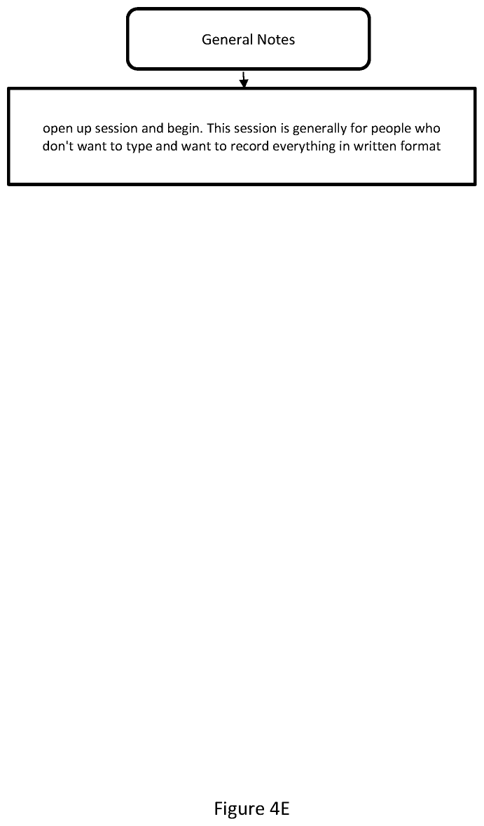

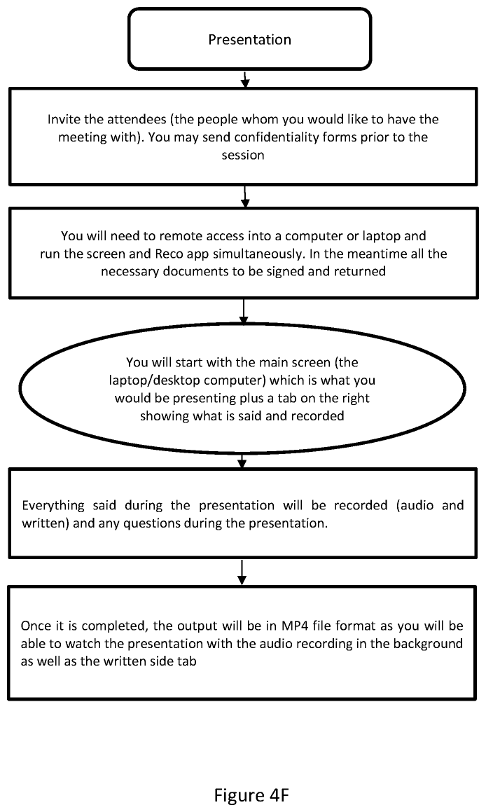

The disclosure has particular, but not necessarily exclusive, application to transcription and transmittal of multi-party communications that occur in the same location and/or across a communications network. However, it should be understood that the disclosure is not limited to this representative embodiment, and may be implemented in relation to other applications, some of which are being illustrated in FIGS. 4A-4F.

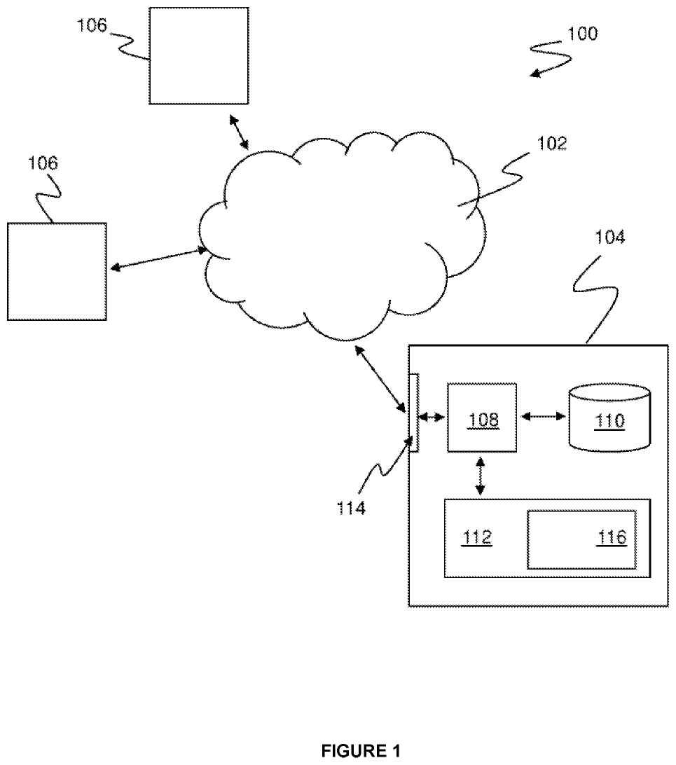

FIG. 1 is a schematic diagram illustrating a system 100 within which embodiments of the present disclosure may be implemented.

The system 100 uses a communications network 102, e.g. the Internet, to facilitate generating and transmitting a transcript of a verbal communication and, more particularly, to facilitate a computer-implemented method and system for automatically generating and transmitting a transcript of a multi-party communication.

In the exemplary embodiment 100, a server 104 executes a web server software application for provision of services to user devices 106. Communication between the server 104 and the user devices 106 is thus conveniently based upon standard hypertext transfer protocol (HTTP) and/or secure hypertext transfer protocol (HTTPS) or by other secure transfer methods.

The user devices 106 (i.e. ‘clients’) are preferably incorporated into, or integrally formed with, mobile devices but may also be coupled (via a communications network) to mobile devices such a smart phones, tablets, notebook computers and so forth. As will be appreciated by persons skilled in the communication arts, various mechanisms and technologies are available to provide access to the Internet 102 from mobile devices 106, and all such technologies fall within the scope of the present invention.

The server 104 may generally comprise one or more computers, each of which includes at least one microprocessor 108. The number of computers and processors 108 generally depends upon the required processing capacity of the system, which in turn depends upon the number of concurrent user devices 106 which the system is designed to support. In order to provide a high-degree of scalability, for example when supporting a global user base, the server 104 may utilise cloud-based computing resources, and/or may comprise multiple server sites located in different geographical regions. The use of a cloud computing platform, and/or multiple server sites, enables physical hardware resources to be allocated dynamically in response to service demand. These and other variations, regarding the server computing resources, will be understood to be within the scope of the present invention, although for simplicity the exemplary embodiments described herein employ only a single server computer 104 with a single microprocessor 108.

The microprocessor 108 is interfaced to, or otherwise operably associated with, a non-volatile memory/storage device 110. The non-volatile storage 110 may be a hard-disk drive, and/or may include solid-state non-volatile memory such as read-only memory (ROM), flash memory, or the like. The microprocessor 108 is also interfaced to volatile storage 112, such as random access memory (RAM), which contains program instructions and transient data relating to the operation of the server 104.

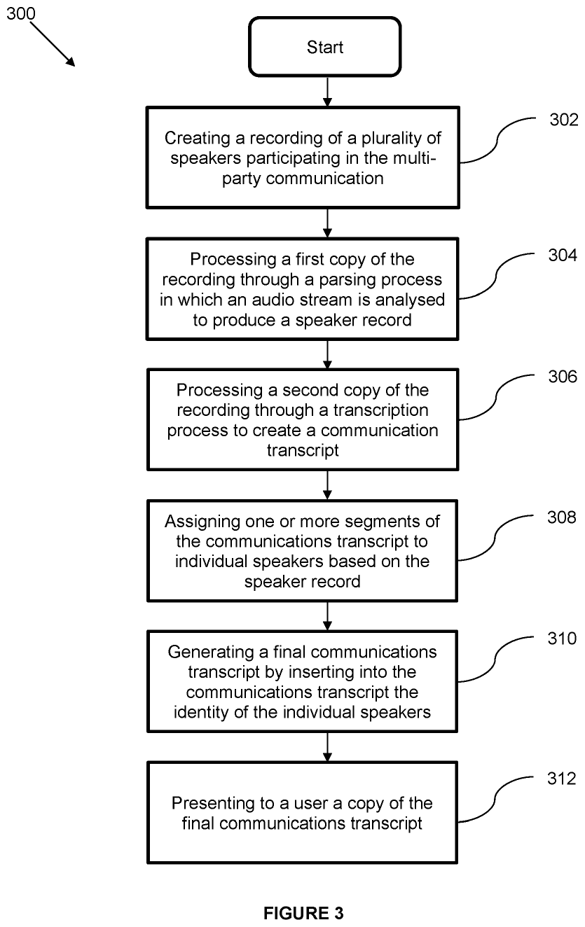

In a conventional configuration, the storage device 110 maintains known program and data content relevant to the normal operation of the server system 104, including operating systems, programs and data, as well as other executable application software necessary to the intended functions of the server 104. In the embodiment shown, the storage device 110 also contains program instructions which, when executed by the processor 108, enable the server computer 104 to perform operations relating to the implementation of services and facilities embodying the present invention, such as are described in greater detail below with reference to FIG. 3 of the drawings. In operation, instructions and data held on the storage device 110 are transferred to volatile memory 112 for execution on demand.

The microprocessor 108 is operably associated with a network interface 114 in a conventional manner. The network interface 114 facilitates access to one or more data communications networks, including the Internet 102, to enable communication between the server 104 and the user devices 106. In use, the volatile storage 112 includes a corresponding body of 116 of program instructions configured to perform processing and operations embodying features of the present invention, for example as described below with reference to FIG. 3 of the drawings.

For example, the program instructions 116 include instructions embodying a web server application. Data stored in the non-volatile 110 and volatile 112 storage comprises web-based code for presentation and/or execution on user devices 106, such as HTML and/or JavaScript code, for facilitating a web-based implementation. Thus, in embodiments of the present invention the system 100 facilitates a user using a user device 106 to access the functionalities of the system 100 via the communications network. For example, the user may access any data files associated with the user's user profile online through a cloud service as known to a person skilled in the art. Additionally, the system 100 may facilitate a user to access at least some functionalities and/or information without accessing the server 104 through the communications network. Specifically, a user may be able to access and/or modify information associated with the user's profile that was previously synchronised with and locally stored on the user's device. Such feature of the system may also be referred to as hybrid application that can provide particular functionality offline, i.e. access and load particular information from a local storage of the user device 106.

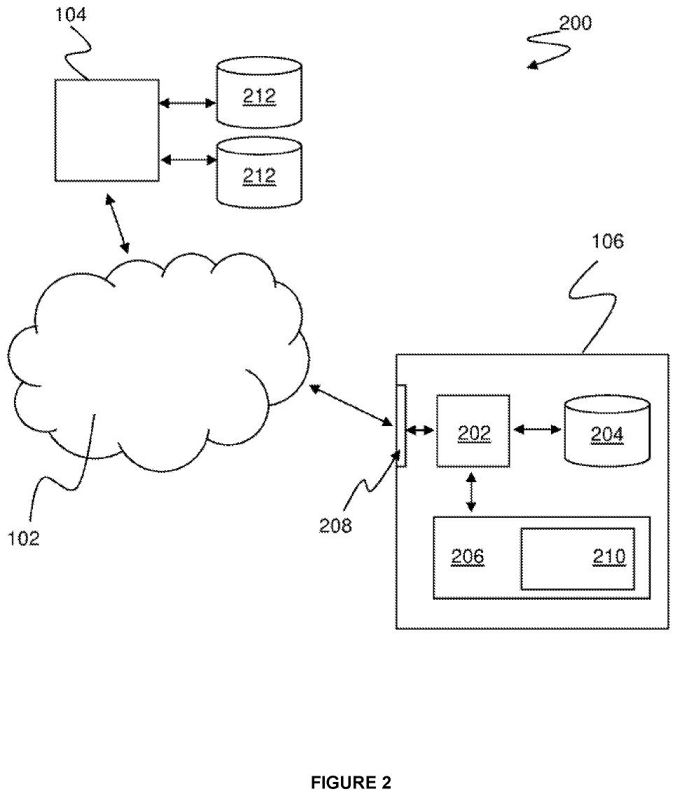

An alternative implementation 200, again by way of example only, is illustrated in the schematic diagram of FIG. 2. In this alternative embodiment, at least a portion of the executable program code implementing the system is executed within the user devices 106. As shown, each user device 106 is typically a computing device contained within a mobile device operated by a user, including at least one microprocessor 202, non-volatile storage 204 and volatile storage 206. Each user device 106 also has a network interface 208, operably associated with the microprocessor 202 in a conventional manner. Accordingly, the user devices 106 are able to conduct computational processing by execution of programs stored locally, in the volatile 206 and non-volatile 204 storage, and/or downloaded via the Internet 102 through the network interface 208.

In the embodiment 200 the server 104 may be in communication with one or more databases 212, which may contain user records and/or profiles (such as, for example, user speech profiles) relating to user information for one or more users, and additionally may include downloadable software components for execution on the user device 106. For example, a portion of the system may be implemented via program instructions developed in a language such as Java, or some other suitable programming language, which execute on the user device 106 in order to retrieve data via the server 104, and implement some or all of the functionality of the exemplary system of automatically generating and transmitting a transcript of a multi-party communication as described below with reference to FIG. 3.

Client-side implementations may also include downloadable and executable code in the form of browser plugins, such as ActiveX controls for Windows-based browsers, and/or other applets or apps configured for execution within a browser environment or within a smartphone operating system environment, such as an Apple iOS environment or an Android environment.

Various implementations of embodiments of the invention will be apparent to persons skilled in the art of software engineering, including various combinations of server-side and client-side executable program components.

Turning now to FIG. 3, there is shown a flowchart which illustrates an exemplary method 300 of generating and transmitting a transcript of a multi-party communication in accordance with an embodiment of the present invention.

A user will typically operate a user device 106, which may either directly or indirectly be in connection with a mobile communications device 106 such as, for example, a smart phone, tablets, notebook computers and so forth. The user device 106 preferably incorporates at least one recording device capable of capturing an audio stream of a multi-party communication (occurring either in a local environment, or partly across a communications bridge facilitated by a communications network). However, a person skilled in the art will appreciate that at least one recording device may alternatively form a separate device, such as a Bluetooth microphone, that is in communication with the user device 106. Additionally, the user device 106 includes a processing unit, memory, and storage as required for a computing device of this type.

The user device 106, incorporating the computing device, preferably runs operating system software and application software that allows the device 106 to be programmed (either directly or remotely) to perform actions based on certain user events. In addition, the device 106 may incorporate one or more radio communication means such as, for example, WiFi, Bluetooth, or cellular data modem radios to allow for transmission of data (including user data such as, for example, user speech profiles) to and from the user device 106. Alternatively, or in addition, the user device may incorporate one or more interface ports to allow the device 106 to be programmed, tested, charged, or simply to allow the direct transmission of data (including user data such as, for example, user speech profiles) into and out of the device 106.

The user device 106 may also contain one or more feedback devices to allow for communication of data or events with the user. These feedback devices may include lights, vibration motors, visual display units (e.g. LCD screens), and/or speakers. Conversely, the device 106 may include one or more input devices to allow for interaction by the user (or person interacting with the device 106). These input devices may include microphones, buttons, dials, and/or touch sensors.

The user device 106 may incorporate one or more internal clocks to provide time base and time reference. As a result, it is possible for the device 106 to aggregate data from each of its sensing devices and timestamp said data, and/or transmit time stamped data to an external system via a communications network. The device 106 is capable of deducing user activity (such as, for example, the commencement of a multi-party communication) based on the aggregation of user data received from its sensing devices, and also capable of storing that user data (in its raw or aggregated form) onboard the device 106.

In order to ensure connectivity to external communication networks (for the purposes, for example, of generating and transmitting a transcript of a multi-party communication in real-time), the user device 106 periodically checks to see if a connection is available to the Internet via one or more of a base station (if one is available to a user and configured), a mobile device (such as, for example, a smartphone or tablet, if one is configured), a WiFi network (if one is available to a user and configured), an onboard or outboard cellular data modem (if one is available to a user and configured). In the event that a base station is configured, the user device 106 may communicate to it using a low power short range radio frequency protocol such as, for example, Bluetooth, WiFi, ZigBee or XBee. Alternatively, if a smartphone is configured or integrally formed with the user device 106, the user device 106 may communicate to it using a low power short range radio frequency protocol such as, for example, Bluetooth, WiFi, or NFC. Alternatively, if an outboard cellular data modem is configured, the user device 106 may communicate to it using a low power short range radio frequency protocol such as, for example, Bluetooth, WiFi, or NFC. Alternatively, if an onboard cellular data modem is configured, the user device 106 may communicate to it using internal bus protocols such as, for example, i2c, NXP, Serial, or other internal intra-component, intra-circuit board or inter component and inter circuit board protocols.

The user device 106 may be programmed to periodically communicate via the Internet with an external server 104 in order to transfer and upload user data (including, for example, user speech profiles) to one or more databases 212. As the user device 106 may be required to receive input from the user at any time, the device 106 may also be programmed to maintain a connection to the Internet at all times, and to immediately seek other means of connectivity in the event that the current means of connectivity is lost or remains unreliable. For example, the user device 106 may be programmed to identify when the connection to the base station (and thus the Internet) is lost, and to immediate traverse a hierarchy of alternative connection means in order to re-establish the connection to the Internet.

At step 302, the method 300 involves creating, via a recording device (preferably located within the user device 106 or communicatively coupled to the user device 106) a recording of a plurality of speakers participating in the multi-party communication. The recording device (not shown) is preferably configured to create a continuous audio recording of the multi-party conversation that can be stored in volatile 206 or non-volatile 204 storage or, preferably, within databases 212 communicatively coupled to the server 104. This continuous audio recording may be stored (stored in volatile 206 or non-volatile 204 storage or, preferably, within databases 212) for an analysis or processing step by the processor 108, 202, and/or transmission, via the communications network 102, to a user and/or a party to the multi-party communication.

Prior to use of the user device 106 by a user, a preferable but optional step may be for the user to register with the system 100 to create a user profile. As part of this process, the user (or an authorised person, such as for example a person administering the transcription of the multi-party communication) may be required to provide various registration details such as, for example, name, address, contact details (including, for example, email address and communication platform details), username and password. In addition, the user (or an authorised person) may be required to submit a user speech sample for the purposes of creating and/or updating a user speech profile. Known techniques and methods for developing a unique speech profile for a user, including but not limited to linguistic profiling, will be understood by those skilled in the art. Such user speech profiles will preferably be used in accordance with the present system 100 for voice recognition processes including ASR software processes. Examples of existing ASR software may include the Cloud Speech-to-Text application programming interface (API) available from Google™, or the Watson™ Speech-to-Text application available from IBM™.

In one specific embodiment, the system 100 may allow for an administrator profile to be created. The user associated with the administrator profile may have the ability to oversee data and instructions performed within the computer server 104 environment. For example, the user associated with the administrator profile may facilitate creating of user profiles, storage and/or deletion of files, such as audio recordings, transcripts, profiles or the like.

All user profiles may be lockable to restrict access to the user profile, for example, by setting a password, pin or other security measures, such as fingerprint or voice ID. Known techniques and methods for securing access to a user profile will be understood by those skilled in the art.

At step 304, the method 300 includes processing a first copy of the recording through a parsing process in which an audio stream is analysed to produce a speaker record identifying one or more portions of the audio stream that correspond to at least one known speaker profile (which is located within volatile 206 or non-volatile 204 storage or, preferably, within databases 212). In accordance with the parsing process, the audio stream may be partitioned into audio samples, or homogeneous segments, according to the speaker identity. In a representative embodiment of the present invention, the parsing process involves a combination of speaker segmentation and speaker clustering. The speaker segmentation element of step 304 preferably involves the identification of speaker change points through either the identification of gaps in the audio stream between speakers involved in the multi-party communication, and/or referencing the at least one known speaker profile to identify the one or more portions of the audio stream that correspond to a speaker matching the at least one known speaker profile. Such referencing may involve calls to stored speaker profiles (i.e. user speech profiles) located within volatile 206 or non-volatile 204 storage or, preferably, within databases 212. The speech clustering element of step 304 involves grouping together speech segments on the basis of speaker characteristics.

In accordance with a representative embodiment of the present invention, the parsing process according to step 304 continues until the final communications transcription is completed. In addition, the method 300 may be conducted such that the final communications transcript is editable. In this way, corrections may be made, or a communications transcript may be continued when a further verbal communication, such as a multi-party communication, takes place. Thus, a continuous meeting thread may be provided to a user and/or one or more parties of the multi-party communication.

In a specific embodiment, the step 304 of processing the first copy of the recording may include filtering the audio stream to reduce background or ambient noise recorded at the at least one recording device 106. Known techniques and methods for reducing or cancelling unwanted noise will be understood by those skilled in the art, including but not limited to active and passive noise control. In one specific example, an AI model tuning technique may be used to improve a sound quality of the verbal communication. In this regard, the method may include a step of providing background or ambient noise recordings, such as noise of a fan, noise of rain etc., to improve the AI model.

At step 306, the method 300 includes processing a second copy of the recording through a transcription process in which the recording is transcribed into one or more text segments to create a communications transcript representative of the multi-party communication. Preferably, a further copy of the recoding is processed via automated speech recognition (ASR) to generate the text segments required for the assembly of the communications transcript. Examples of such an ASR software may include the Cloud Speech-to-Text application programming interface (API) available from Google™, or the Watson™ Speech-to-Text application available from IBM™. It is also envisioned that the step 304 of processing a first copy through a parsing process and the step 306 of processing a second copy through a transcription process occur simultaneously. Even more so, it is envisioned that the steps 304 and 306 may be conducted at substantially real-time to provide a substantially live communications transcript to a user and/or party of the multi-party communication.

In one particular embodiment, the transcription process according to step 306 may comprise automatically correcting the one or more text segments. For example, the one or more text segments may be analysed and optionally automatically corrected for spelling, grammar, punctuation or other corrections. With regard to a spellcheck, a person skilled in the art will appreciate that a user may pre-define rules for autocorrection. For example, a user may pre-define a rule for changing specific abbreviated terminology into the corresponding expanded terminology. As an extension of the above, the method 300 may comprise an additional step of providing a dictionary and presenting a meaning, definition or synonym of a word within a text segment upon selecting the work. At step 308, the method includes assigning one or more segments of the communications transcript to individual speakers based on the speaker record. More specifically, this step 308 preferably involves aligning the speaker record with the communications transcript based on audio and/or textual cues, and allocating the identity of individual speakers to each of the one or more text segments based on the at least one known speaker profile. As will be appreciated by those skilled in the art, the system 100 may include one or more internal clocks to provide time base and time reference. As a result, it would be possible for the device 106 to aggregate and timestamp said data, and/or transmit time stamped data to an external system via a communications network, as part of the process 308 of assigning one or more segments of the communications transcript to individual speakers based on the speaker record.

As described above, in this particular embodiment first and second copies of the recording are processed through a parsing process and a transcription process, respectively. However, a person skilled in the art will appreciate that one or more of the processing steps may be conducted on the original recording (if preferred), or that only one copy of the recording will be created for data processing.

At step 310, the method includes generating a final communications transcript by inserting into the communications transcript, based on the at least one known speaker profile, information identifying the individual speakers. This step 310, preferably involves inserting into the communications transcript, based on the at least one known speaker profile (which is located within volatile 206 or non-volatile 204 storage or, preferably, within databases 212), the identity of the individual speakers, and/or inserting into the communications transcript an unknown speaker marker where the identity of the individual speaker is unknown from the at least one known speaker profile. For example, an unknown speaker marker may identify a speaker by a non-specific designation (such as, for example, ‘Speaker 1’ or ‘Speaker A’) in the event that an identified speaker is not matched to the at least one known speaker profile.

At step 312, the method includes presenting to a user, via the communications network 102 and preferably on a feedback device (such as, for example, the graphical user interface of the user device 106), a copy of the final communications transcript. As a preferable preliminary step, the step 312 involves encrypting the final communications transcript and/or the continuous audio recording, and transmitting, via the communications network 102, the encrypted final communications transcript and/or the encrypted continuous audio recording (including, for example, a continuous audio and video recording) to the user and/or a party to the multi-party communication. Techniques for encryption of textual transcripts as well as audio/video files (in either compressed or uncompressed formats) will be known to those skilled in the art.

It should also be appreciated that the step 312, may include the preliminary step of translating the text of all or part of the final communications transcript into a language different to the language spoken by users during the multi-party communication. The translation of the final communications transcript may be requested by users in advance based on functional user preferences specified in the user's profile stored within volatile 206 or non-volatile 204 storage or, preferably, within databases 212. This feature has the particular advantage that if segments of the audio stream are transcribed in substantially real-time, live communications between parties that speak different languages can be enabled without significant delay. In a representative embodiment of the present invention, the translation of all or part of the final communications transcript into a language different to the language spoken by users during the multi-party communication may be conducted using third-party translation software (such as, for example, Google™'s Cloud Translation software).

It should also be appreciated that as an alternative (or in addition to) presenting to a user the final communications transcript on or via a mobile device 106, it may also be desirable for a copy of the final communications transcript to be sent to a user via an existing or known email account, or communication platform account.

Examples of possible applications and use cases for the system 100 will now be described with reference to practical situations that would benefit from the use of automated transcription services. A schematic overview of some examples of possible applications are further shown in FIGS. 4A to 4F of the accompanying drawings.

### Corporate Meetings

During a typical corporate meeting, a user device 106 may be operated used by, for example, the initiator of the meeting (or their delegate) to commence the method 300 of generating and transmitting a transcript of a multi-party communication. This may be implemented by providing a calendar integration feature. For example, the system 100 may facilitate a user, such as the initiator of the meeting, to create and schedule a meeting via an integrated calendar that will notify invited users with information in relation to the scheduled meeting. The information may comprise a date and time of the meeting, an agenda, any documents associated with the meeting and log in details to attend the meeting.

For a meeting with known attendees, each of which has previously established and stored a user profile on the database 212, the initiator of the meeting may invite (via the user's profile) each user to the meeting so that the multi-party communication can commence. If any attendees have not previously established and stored a user profile on the database 202, then, for example, the method 300 may facilitate the creation of an ad hoc user profile by requesting the user to verbally state their name and profession. This may also be referred to as enrolment process. For example, the method 300 may comprise a step of generating and presenting a selectable link to a new user or guest to initiate the enrolment process.

If a profile has not been created for a particular user participating the multi-party communication then portions of the final communications transcript corresponding to that user will be marked with a non-specific designation (such as, for example, ‘Speaker 1’ or ‘Speaker A’). However, the system 100 will still recognise that user's voice as unique and identifiable.

According to the method 300, the system 100 may also have the additional functionality to enable text documents (such as, for example, Word™ or Rich-Text-Format documents) to be processed and imported (and stored within volatile 206 or non-volatile 204 storage or, preferably, within databases 212) to enable population of certain fields. In a representative embodiment of the present invention, and by way of example only, the imported text may be used to populate certain fields associated with action items. For example, and prior to a corporate meeting between multiple users, text documents may be processed to extract information about an agenda for that meeting, which can then be stored (within volatile 206 or non-volatile 204 storage or, preferably, within databases 212) and used as ‘action items’ or placeholders for allocation of voice-to-text transcription for speakers within the multi-party communication.

An illustrative example of an agenda with inserted voice-to-text transcription of speakers is provided below:

### 1.0 Safety

1.1: Steve Smith 4-19-2019 10:46:30 AM:
Has the safety report been done?
1.2: Dylan Garyson 4-19-2019 10:46:55 AM:
Yes, I Believe Sarah Done it.
1.3: Sarah Pratt 4-19-2019 10:47:22 AM:
Yes, I completed it yesterday and send it around for review.
1.4: Steve Smith 4-19-2019 10.17:40 AM:
Sounds good, thank you

### 2.0 Achievements

2.1: Steve Smith 4-19-2019 10:48:30 AM:
Has the Telstra tower been installed?
2.2: Dylan Garyson 4-19-2019 10:49:01 AM:
Yes, Optus have done the works.
2.3: Sarah Prat 4-19-2019 10:49:07 AM:
Was there an as-con done for this?
2.4: Steve Smith 4-19-2019 10:49:15 AM:
Yes, GHD has done this.

### 3.0 Issues/risk

3.1: Steve Smith 4-19-2019 11:15:05 AM:
I noticed that there was some western power cables in the vicinity, has this been looked at in terms WP codes.
3.2: Dylan Garyson 4-20-2019 11:15:18 AM:
Umm . . . this wasn't shown on the drawings?
3.3: Sarah Pratt 4-20-2019 11:15:46 AM:
I think we should get a survey done ASAP.
3.4: Steve Smith 4-20-2019 11:16:05 AM:
Yes, we may need to get GHD to come in to do this.

As will be appreciated by a person skilled in the art, the final communications transcript may further comprise labels, such as date and time stamp, full name and location of the meeting or each speaker.

Instead of manually selecting an agenda item for insertion of the voice-to-text transcription, the system 100 may provide the functionality of automatically allocating an agenda item to an audio segment. In this way, the agenda item will be inserted into the final communications transcript preceding the allocated and transcribed audio segment. In this regard, the system 100 may utilise a learning algorithm to group one or more audio segments and assign one or more audio segments to an existing agenda item. Alternatively, in the absence of imported information about an agenda, the system 100 may provide the functionality of determining a topic for one or more audio segments and grouping the one or more audio segments of the audio stream to the determined topic.

Additionally or alternatively, the system 100 may provide the functionality of creating or allocating a task to a user and/or a group and/or a party of the multi-party communication. The task may be allocated a deadline for when the task will need to be completed by the user. Furthermore, the system 100 may provide information indicative of a portion of the task being completed, for example, in the form of a percentage. This is particularly advantageous if a task is allocated to a group of users.

As an extension of the above, the system 100 may provide the functionality of automatically identifying and extracting or highlighting a pre-defined type of information, such as ‘action items’, ‘follow up items’ or ‘contact information’. In this regard, the system 100 may provide the functionality of identifying the pre-defined type of information based on a format of the information or determining a sentiment of an audio segment. For example, with regard to contact information, the system 100 may use an algorithm to identify information indicative of an address, a postcode, a name, an email address or the like. In this regard, the algorithm may be construed to recognise when a speaker mentions the ‘@’ symbol of an email address, a telephone number or a postcode.

The system 100 may automatically extract or highlight the pre-defined type of information in the final communications transcript. For example, the system 100 may provide the functionality of hyperlinking the pre-defined type of information such that upon selecting the hyperlink, a user of the platform will be redirected to website, a telephone application, a direct message application or the like. Even more so, the system 100 may comprise an integrated telephone functionality, email functionality and/or direct message functionality. A person skilled in the art will appreciate that integrating these types of functionalities into a computer system are well known in the art and will not be further described in the present specification.

Furthermore, the system 100 may automatically recognise if a user is mentioned in the audio stream. In this instance, the system 100 may automatically notify the mentioned user via email or other messaging functionality. This may be transcribed in the final communications transcript by inserting information indicative of the automatic notification, such as in the format of “Notify@TimJones”.

Additionally or alternatively, the system 100 may facilitate a user to mark, such as highlight or flag, one or more text segments. In this way, the final communications transcript may function as a reminder or task list to the user.

Furthermore, the system 100 may provide the functionality of providing the communications transcript of all or part of the audio stream in an editable format. In this regard, the system 100 may restrict editing of a text segment to the allocated speaker. Any edits to a text segment may be marked, for example, by highlighting the edit and/or inserting a time stamp of the edit. In this way, only the user that is allocated to the transcribed audio segment can edit, such as correct, the corresponding text segment. In this way, any incorrect transcription or formatting can be corrected in substantially real-time.

As an extension, the system 100 may have the functionality of editing the communications transcript by adding further text segments to it after the initial meeting has finished. For example, the initiator of the first meeting may organise a further meeting with the same or similar parties of the previous multi-party communication. Any transcribed audio segments may be added as text segments to the existing communications transcript. In this regard, the system 100 may allow for referencing to a previous text segment. The referenced text segment may be identified as a quote in the final communications transcript.

As an extension, and also by way of representative example, the system 100 may also have the functionality to store within volatile 206 or non-volatile 204 storage or, preferably, within databases 212) certain document files that would be typically required to be exchanged between speakers in a multi-party communication. For example, it is typical for parties to a confidential communication to exchange, prior to that communication, a non-disclosure agreement (NDA) that is signed by all parties to that communication. It is envisioned that the system 100 may have the additional functionality to allow such a document to be exchanged between parties scheduled to be involved in a multi-party communication, and electronically signed and stored (within volatile 206 or non-volatile 204 storage or, preferably, within databases 212) where required. As an extension, the system 100 may automatically restrict a user to attend a verbal communication and/or receiving a shared file, if the system 100 does not detect a signed NDA within the database 212. Furthermore, the system may provide the functionality of tracking and/or identifying documents and/or files that have been shared within the multi-party communication and/or outside of the communication.

In more general terms, the system 100 may have the functionality of organising and storing any suitable files within the volatile 206 or non-volatile storage 204, including but not limited to transcript files, audio files and any uploaded, downloaded and shared filed.

Furthermore, and also by way of representative example, the system 100 may provide the functionality to allow users to communicate with other users on the platform 100 (i.e. users with which a multi-party communication may occur and/or those users that have established a user profile with the system 100). This may be realised via an ‘instant messaging’ function, an emailing function or a director or conference calling function. These functionalities to enable communication between users will be known to those skilled in the art. The primary purpose of this functionality will be to enable users to communicate in a non-verbal context, either to facilitate communications or to assist with the scheduling of multi-party verbal communications via the platform 100.

Audio and/or Video Conference Call

This example relates to a typical audio or video conference call that may take place between two or more parties to a multi-party communication. As opposed to the above example of a corporate meeting (e.g. board or committee meeting), an audio or video conference call may occur between two or more users without advance notice, and may occur either through a cellular or data communications network 102 (using, for example, third party conferencing or communications applications). The commencement of an audio or video call between two or more users may trigger the method 300 of generating and transmitting a transcript of a multi-party communication. At the completion of the audio or video call between the users, or based on pre-stored user preferences, the users may receive a notification via their mobile device 106 to request a copy of the final communications transcript (either directly to their mobile device 106 via the system application, or via an alternate communication means such as, for example, the user's email).

### Presentation/Question & Answer Session

This example relates to a question and answer session, for example, in the form of a lecture or presentation presented to one or more attendees. In this particular example, a user device 106 may be operated by, for example, the presenter of the lecture (or their delegate) to commence the method 300 of generating and transmitting a transcript of the lecture or presentation. Generating and transmitting a transcript of the lecture or presentation to the attendees has the particular advantage that attendees are able to focus on listening to the presenter instead of taking notes. This is particularly advantageous, if the method is conducted to be performed in substantially real-time so that a live communications transcript is provided to the attendees.

In a specific embodiment, the system 100 may provide the functionality to allow an attendee to pose a question or comment to the presenter of the lecture. In this regard, the system 100 may facilitate an attendee to input the question or comment in writing using a client device, such as client device 106. The question or comment may be displayed only to the presenter or to the presenter and the attendees. For example, the question or comment may be highlighted to the presenter on a display so that the presenter is able to provide an answer to the question or comment. In order to provide this functionality, the system 100 may generate and provide a selectable link and/or access code to be presented to attendees and/or interested parties of the lecture. Alternatively, the system 100 may facilitate an attendee to input the question or comment verbally using a client device, such as client device 106. The method 300 will then perform the parsing and transcription process to insert the question or comment in the final communications transcript.

Allowing an attendee to pose a question to the presenter has the advantage of making the lecture or presentation more interactive without necessarily interrupting the presenter while holding the lecture. For example, the questions or comments may be presented to the presenter in real-time or at the end of the lecture.

In addition, the system 100 may provide the functionality to allow an attendee to communicate with the presenter or other attendees on the platform via an ‘instant messaging’ function. In this way, an attendee may pose a question to the presenter in private without it necessarily being published in the final communications transcript.

According to the method 300, the system 100 may also have the additional functionality to enable images (such as photographic images, hand written notes or the like in any suitable image formats) to be processed and imported (and stored within volatile 206 or non-volatile 204 storage or, preferably, within databases 212). For example, a user may capture an image with the user device 106 which is then transmitted for further processing to the computer server 104. In this regard, the system 100 may provide a whiteboard feature as known to those skilled in the art. In a specific embodiment, the system 100 may have the functionality of converting the imported image into text and/or extracting text from the imported image. For example, the presenter may capture a photographic image of a white board to be processed and imported into the final transcript. Techniques for extracting text from an image will be known to those skilled in the art.

As the present invention may be embodied in several forms without departing from the essential characteristics of the invention, it should be understood that the above described embodiments should not be considered to limit the present invention but rather should be construed broadly. Various modifications, improvements and equivalent arrangements will be readily apparent to those skilled in the art, and are intended to be included within the spirit and scope of the invention. The present embodiments are, therefore, to be considered in all respects as illustrative and not restrictive.

1. A method of generating and transmitting a transcript of a verbal communication, the method comprising:
creating a recording of at least one speaker participating in the verbal communication;
processing the recording through a parsing process in which an audio stream is analysed to produce a speaker record automatically identifying one or more portions of the audio stream that correspond to at least one known speaker profile;
processing the recording through a transcription process in which the recording is transcribed into one or more text segments to create a communications transcript representative of the verbal communication;
assigning one or more segments of the communications transcript to the at least one speaker based on the speaker record;
generating a final communications transcript by inserting into the communications transcript, based on the at least one known speaker profile, information identifying the at least one speaker; and
presenting to a user a copy of the final communications transcript.

2. The method according to claim 1, wherein the step of creating a recording involves creating a continuous audio recording of the verbal communication.

3. The method according to claim 2, wherein the continuous audio recording is stored for one or more of:
an analysis or processing step; and
transmission to a user and/or a party to the verbal communication.

4. The method according to claim 1, wherein the verbal communication relates to a multi-party communication and the step of processing the recording through a parsing process includes the steps of:
segmenting the audio stream into one or more individualised speaker segments; and
grouping the one or more individualised speaker segments based on common speaker elements.

5. The method according to claim 4, wherein the step of segmenting the audio stream further includes the step of identifying speaker change points in the audio stream.

6. The method according to claim 5, wherein the step of identifying speaker change points includes one or more of:
identifying gaps, in the audio stream, between speakers involved in the multi-party communication; and
referencing the at least one known speaker profile to identify the one or more portions of the audio stream that correspond to a speaker matching the at least one known speaker profile.

7. The method according to claim 1, wherein in the step of processing the recording through a transcription process includes the further step of generating the text segments via automated speech recognition.

8. The method according to claim 1, wherein the step of assigning one or more segments of the communications transcript includes the steps of:
aligning the speaker record with the communication transcript based on audio and/or textual cues; and
allocating the information identifying the at least one speaker to each of the one or more text segments based on the at least one known speaker profile.

9. The method according to claim 1, wherein the information identifying the at least one speaker may comprise one or more of:
first and/or second name of an individual speaker;
profession of an individual speaker;
company information;
contact information of an individual speaker;
location information;
date and/or time stamp information; and
an unknown speaker marker where the identity of an individual speaker is unknown from the at least one known speaker profile.

10. The method according to claim 1, wherein the step of processing the recording through a parsing process and the step of processing the recording through a transcription process occur substantially simultaneously.

11.-12. (canceled)

13. A computer-implemented system of generating and transmitting a transcript of a verbal communication, the system comprising:
a recording device for recording at least one speaker participating in the verbal communication; and
a processing system configured to perform the method of claim 1, wherein the processing system is a server processing system.

14. A computer-implemented system of generating and transmitting a transcript of a verbal communication, the system comprising:
a computer server accessible through a communications network, the computer server arranged to receive information about the verbal communication through the communications network;
a processor, communicatively coupled to the computer server, to one or more display devices for displaying information, and to one or more input devices for receiving input from a user, the processor being configured to:
create, via a recording device, a recording of at least one speaker participating in the verbal communication;
process the recording through a parsing process in which an audio stream is analysed to produce a speaker record automatically identifying one or more portions of the audio stream that correspond to at least one known speaker profile;
process the recording through a transcription process in which the recording is transcribed into one or more text segments to create a communications transcript representative of the verbal communication;
assign one or more segments of the communications transcript to the at least one speaker based on the speaker record;
generate a final communications transcript by inserting into the communications transcript, based on the at least one known speaker profile, information identifying the at least one speaker; and
present to a user, via the communications network, a copy of the final communications transcript.

15. The computer-implemented system according to claim 14, wherein in the step of creating a recording of a plurality of speakers, the processor is further configured to create a continuous audio recording of the verbal communication.

16. The computer-implemented system according to claim 15, wherein the continuous audio recording is stored for one or more of:
an analysis or processing step by the processor; and
transmission, via the communications network, to a user and/or a party to the verbal communication.

17. The computer-implemented system according to claim 14, wherein the verbal communication relates to a multi-party communication and the step of processing the recording through a parsing process, the processor is further configured to:
segment the audio stream into one or more individualised speaker segments; and
group the one or more individualised speaker segments based on common speaker elements.

18. The computer-implemented system according to claim 17, wherein the processor is further configured to identify speaker change points in the audio stream.

19. The computer-implemented system according to claim 18, wherein identifying speaker change points includes one or more of:
identifying gaps, in the audio stream, between speakers involved in the multi-party communication; and
referencing the at least one known speaker profile to identify the one or more portions of the audio stream that correspond to a speaker matching the at least one known speaker profile.

20. The computer-implemented system according to claim 14, wherein in the step of processing the recording through a transcription process, the processor is further configured to generate the text segments via automated speech recognition.

21. The computer-implemented system according to claim 14, wherein the step of assigning one or more segments of the communications transcript includes the steps of:
aligning the speaker record with the communication transcript based on audio and/or textual cues; and
automatically allocating the identity of individual speakers to each of the one or more text segments based on the at least one known speaker profile.

22. (canceled)

23. The computer-implemented system according to claim 14, wherein prior to the step of presenting to a user a copy of the final communications transcript, the processor is further configured to:
encrypt the final communications transcript and/or the continuous audio recording; and
transmit, via the communications network, the encrypted final communications transcript and/or the encrypted continuous audio recording to a user and/or a party to the verbal communication.

24.-29. (canceled)
